(19) United States
(12) Patent Application Publication
(10) Pub. No.: US 2010/0058694 A1
(43) Pub. Date: Mar. 11, 2010

(54) IMPARTING WATER REPELLENCY TO LAMINATE AND PARQUET EDGES

(75) Inventor: Franz Eiden, Armsheim (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Bostik, S.A., Courbevoie (FR)

(21) Appl. No.: 12/522,452

(22) PCT Filed: Dec. 27, 2007
(86) PCT No.: PCT/EP2007/011425

§ 371 Date: Nov. 20, 2009

(30) Foreign Application Priority Data
Jan. 10, 2007 (DE) 10 2007 002 395.4

(51) Int. Cl. E04F 13/076; B27K 3/02

(52) U.S. Cl. 52/392; 427/297; 427/298

(57) ABSTRACT

The present invention discloses the composition of a one-component, solvent-free water repellent for sealing joint and cut edges and tongue and groove of laminate and parquet floor elements laid without adhesive. The water repellent consists of saturated fatty acids having at least 10 carbon atoms in proportions by mass of 60 to 95%, preferably stearic acid, and plasticizers in proportions by mass of 5 to 40%, and optionally dyes, wetting agents and preservatives. Paraffinic white oils and silicone oils are used as plasticizers.

The present invention relates to a water repellent for imparting water repellency to laminate or parquet edges.

Laminate and parquet boards are wood-base materials which are predominantly used as floor coverings and have a layer structure. The uppermost layer of the laminate panels forms the top layer and generally consists of melamine resins. The decorative paper is present underneath. The next layer is a support which holds the panels together. HDF boards, MDF boards or in simpler cases also plywood boards are used for this purpose. The underside of the laminate panels is formed by the so-called counteracting layer which is intended, inter alia, to prevent moisture from diffusing into the laminate.

The support sheet of the laminate panels is now frequently provided with a click or snap connection. This makes it possible to lay said systems in a simple manner and in particular without adhesive.

The conventional laminate and also parquet elements are held together by a tongue and groove joint. To avoid joint formation, but also as protection from moisture, all seams must be adhesively bonded or glued.

In the case of the click or snap systems, both in laminate and in parquet floors, the special profile or special milling makes it easy to click or push the tongue into the groove. The advantages of this technique are the shorter laying time and the simpler laying technique, which also enables the unpractised do it yourself worker to carry out laying himself. In addition, damaged or scratched floor elements can easily be replaced.

However, the technique described also has a serious disadvantage. Experience with these click and push systems has in fact shown that moisture can relatively easily penetrate into the joints between the floor elements. The consequence then is that the support sheet swells and rises. This effect is further enhanced if the laminate or parquet elements were not laid completely flat.

In order to prevent penetration of moisture into the wood-base material, for example from wash water, prior art proposed various coatings of the tongue and groove elements.

DE 19547864 proposes treating the floor elements first with an aqueous emulsion of paraffin, wax or silicones. This is followed by adhesive bonding with an aqueous dispersion adhesive. It is obvious that this proposal has few prospects for success since the aqueous water repellent itself must lead to swelling of the wood elements and the aqueous adhesives used also cause further swelling of the wood and on the other hand are also not moisture-stable. In addition according to the teaching of this application, the emulsion having a water-repellent effect is to be applied only to one of the two surfaces to be adhesively bonded while the second surface remains untreated.

GB 2128091 describes substantially wood preservatives based on oil alkyd resins, organic solvents, drying agents and biocides. In order to achieve a certain protection from moisture, addition of very small proportions (about 0.5% by mass) of wax is recommended. For the solution of the present problem, the resin formulation described is not very helpful since the swelling problem of wood-base materials is not discussed.

DE 3942136 recommends an impregnating agent consisting of 65 to 99% by mass of siccative natural oils or natural resins and hard waxes for the treatment of wood-base materials. The problem of swelling of parquet and laminate floor elements on contact with water is not discussed. In addition the setting time of the claimed formulations is several days, so that the use for continuous industrial production is ruled out. DE 4020495 describes a liquid impregnating agent with finishing for wood. It consists of more than 50% of organic solvents, isocyanate-modified linseed oil and a number of further additives. The agent is said to impregnate and finish wood. The prevention of wood swelling with water is not disclosed. In addition, however, the difficulty with formulations having such a high solvent content are generally known and usually prohibitive for technical use.

Finally, DE 10051978 discloses a water-repellent treatment for laminate floors to be laid without glue: liquid formulations comprising 60 to 95% by weight of drying oils, 5 to 40% by weight of wax and drying agents, wetting agents and antifoams are claimed. The formulation is liquid at room temperature and dries only very slowly. DE 10051987 mentions drying times of three days. For industrial manufacturing processes for the treatment of laminate or parquet floor elements, such long drying times are not acceptable. Moreover, it should be noted that the parquet or laminate elements are packed in paper or board for sale. However, incompletely dried oil- containing formulations of the above type lead to penetration of oil into the packing material, which greatly adversely affects the sale because the customer regards the penetration of oil as soiling.

Against the technical background described, it was an object of the present invention to provide a one-component, solvent-free water repellent setting within seconds for coating the edges of laminate and parquet floor elements laid without adhesive. This object is achieved by the features stated in Patent Claim 1 and by Subclaims 2 to 5.

The claimed saturated fatty acids are alkanecarboxylic acids having 10 or more carbon atoms. In practice, they begin with capric acid and extend to cerotic acid having 26 carbon atoms and a melting point of 87° C. In addition to pure fatty acids, all possible mixtures of the claimed fatty acids can of course also be used. Characteristic of said fatty acids are the hydrophilic carboxyl groups and the hydrophobic carbon chains. The result of this conflicting chemical structure is that the fatty acid molecules are lying parallel to one another and therefore have a water-repellent effect.

According to Claim 2 of the present invention, paraffinic white oil is present as a plasticizer in proportions by mass of 5 to 40% in the claimed water repellents. White oils are colourless oils; they consist of paraffin hydrocarbons and are insoluble in water. The density varies between 0.82 to 0.89 kg/l, depending on composition. As an alternative to white oil, polydimethylsiloxanes, colloquially referred to as silicones, may also be used as plasticizer in proportions by mass of 5 to 40%. Polydimethylsiloxanes are linear polycondensates having molar masses between 800 and 100 000 g/mol. They are clear, colourless and odourless liquids. Characteristic of this class of compound is the high spreading power, which is the reason for the hydrophobic properties of the silicone oils.

A particularly preferred embodiment of the present invention is given by Patent Claim 4. According to this claim, the water repellent consists of 70 to 85% by mass of stearic acid and 30 to 15% by mass of white oil as a plasticizer. Stearic acid or octadecanoic acid is a white to pale yellow, odourless solid which is practically insoluble in water. The melting point in the case of industrial products is about 60° C. Stearic acid is obtained from vegetable and industrial fats. It is toxicologically safe.

The mixture of the two constituents, stearic acid and white oil, can be prepared in a simple mechanical manner; it is solid at room temperature but melts at moderate temperatures of about 60° C.; after application, the water repellent solidifies within a few seconds and penetrates deeply into the wood-base material to be treated. On admission of water, the water repellent treatment effectively prevents the penetration of moisture into the parquet or laminate elements at cut edges and in tongue and groove regions.

According to a further feature of the present invention, wax-soluble dyes can be mixed into the claimed water repellents. Suitable dyes should dissolve homogeneously and be uniformly distributed in the melts of the water repellents. The amounts used are between 0.2 and 2% by mass, depending on the desired shade and the desired depth of colour.

Oil-soluble dyes from the series consisting of the solvent types meet these requirements particularly well. An example of a suitable green dye is Solvent Green 28 (C₃₄H₃₄N₂O₄). Details of these dyes are to be found in Colour Index 4th Edition, Great Britain, and further information can therefore be dispensed with here. Other possible additives according to the prior art, which may be useful from case to case, are wetting agents, such as, for example, fluorosilicones or polyether-modified dimethylpolysiloxanes, or deaerators. Biocidal additives, for example from the group consisting of the isothiazolinones, are suitable for preservation.

The water repellents according to the invention are used in the industrial production of the corresponding laminate and parquet floor elements. Application is effected in the region of the joint flanks and cut edges and especially in the particularly endangered regions of tongue and groove, by the vacuum spray method at operating temperatures of 60 to 100° C. The nozzles of these application machines are shaped according to the profiles of the click connections and thus permit a thin, adjustable coat. The coats cure as soon as the temperature falls below the melting points of about 60° C. The setting times of the water repellents according to the invention are therefore in the region of a few seconds. The required industrial manufacturing speed is therefore ensured.

The emergence of oil feared in the case of other water repellents, i.e. soiling of the packagings, due to fat- and oil-containing sealing agents does not occur because the claimed water repellent is solid at room temperature.

The water-repellent effect of the water repellent according to the invention is surprisingly strong; even after storage in water for 24 hours, only minimum swelling occurs. Further information in this context appears in Table 1.

In addition, after prior treatment with the water repellent, the swelling proved to be reversible, i.e. the swelling was substantially eliminated after removal of the moisture.

### EXAMPLES

### Example 1

8 kg of stearic acid are initially introduced into a mixer and heated to 70° C. with constant stirring and 2 kg of white oil (density 0.85 kg/l) are then admixed in the course of 5 min. The hot mixture can be conveniently introduced into storage containers or sales containers.

After cooling to below 50° C., the water repellent is present in solid form. Even as a solid substance, filling is possible in a simple manner.

### Example 2

10.0 kg of stearic acid are homogeneously mixed with 2.0 kg of polydimethylsiloxane (silicone oil, viscosity 5000 mm²/s) and 0.4 kg of Solvent Green 28 at 70° C.

### Example 3

0.50 kg of behenic acid is homogeneously mixed with 0.05 kg of white oil (density 0.83 kg/l) and 0.001 kg of 2-N-octyl-4-isothiazolinone at 90° C. The water repellent solidifies at about 75° C.; it can be filled while hot or in solid form after solidification.

For testing of the swelling behaviour with water, parquet or laminate floor elements were sealed at the cut edges, at the joint surfaces and in the tongue and groove regions with the water repellents according to Examples 1 to 3, and the swelling behaviour was then tested by storage in water at 25° C. The swelling was determined by weighing and is stated in % (Table 1).

TABLE 1

| Storage in water | Swelling in % | Swelling in % | Swelling in % |
|---|---|---|---|
| Time | Example 1 | Example 2 | Example 3 |
| 1 hour | 0 | 0 | 0 |
| 4 hours | 0.2 | 0.3 | 0.1 |
| 12 hours | 0.3 | 0.3 | 0.2 |
| 24 hours | 0.4 | 0.4 | 0.2 |

1. A method of imparting water repellency to the region of the joint and cut edges and tongue and groove of laminate and parquet floor elements laid without adhesive comprising applying a water repellent composition to said region of the joint and cut edges and tongue and groove said composition comprising saturated fatty acids having at least 10 carbon atoms in proportions by mass of 60 to 95%, and plasticizers in proportions by mass of 5 to 40%.

2. The method according to claim 1, wherein the plasticizer comprises white oil based on paraffins.

3. The method according to claim 1, wherein the plasticizer comprises polydimethylsiloxanes.

4. The method according to claim 1, wherein the saturated fatty acids having at least 10 carbon atoms comprise stearic acid and the plasticizer comprises white oil based on paraffins.

5. (canceled)

6. The method according to claim 4, wherein the stearic acid is present in proportions by mass of 70 to 85%.

7. The method according to claim 6, wherein the white oil is present in proportions by mass of 15 to 30%.

8. The method according to claim 1, wherein said composition further comprises dyes, deaerators, wetting agents, preservatives or mixtures thereof.

9. The method according to claim 8, wherein the dyes comprise wax-soluble dyes.

10. The method according to claim 9, wherein the dyes are present in proportions by mass of 0.2 to 2%.

11. The method according to claim 1, wherein said composition is applied to said region by a vacuum spray method at an operating temperature of 60° C. to 100° C.

12. A method of imparting water repellency to the region of the joint and cut edges and tongue and groove of laminate and parquet floor elements laid without adhesive comprising applying a water repellent composition to said region of the joint and cut edges and tongue and groove said composition comprising saturated fatty acids having at least 10 carbon atoms and plasticizers.

13. A laminate or parquet floor comprising joint and cut edge regions and/or tongue and groove regions wherein the joint and cut edge regions and/or tongue and groove regions comprise a water repellent composition comprising one or more saturated fatty acids having at least 10 carbon atoms and one or more plasticizers.

14. The floor according to claim 13, wherein the composition further comprises dyes, deaerators, wetting agents, preservatives or mixtures thereof.

15. The floor according to claim 14, wherein the dyes comprise wax-soluble dyes.

16. The floor according to claim 13, wherein the one or more saturated fatty acids having at least 10 carbon atoms are present in proportions by mass of 70 to 85% and the one or more plasticizers are present in proportions by mass of 15 to 30%.

17. The floor according to claim 13, wherein the one or more plasticizers comprise white oil based on paraffins.

18. The floor according to claim 13, wherein the one or more plasticizers comprise polydimethylsiloxanes.

19. The floor according to claim 13, wherein the one or more saturated fatty acids having at least 10 carbon atoms comprise stearic acid.

20. The floor according to claim 19, wherein the one or more plasticizers comprises white oil based on paraffins.
